(19) United States
(12) Patent Application Publication
(10) Pub. No.: US 2026/0356109 A1
(43) Pub. Date: Nov. 12, 2026

(54) MEDIUM TRANSPORT DEVICE AND RECORDING DEVICE

(71) Applicant: SEIKO EPSON CORPORATION, Tokyo (JP)

(72) Inventors: Shinya KAWABATA, Shiojiri-shi (JP); Masashi OGAWA, Shiojiri-shi (JP)

(21) Appl. No.: 19/671,478

(22) Filed: May 8, 2026

(30) Foreign Application Priority Data
May 8, 2025 (JP) 2025-078199

(51) Int. Cl. B41J 13/02; B41J 13/03; B41J 13/076; B41J 13/10; B41J 29/13

(52) U.S. Cl. CPC B41J 13/025; B41J 13/03; B41J 13/076; B41J 13/103; B41J 29/13

(57) ABSTRACT

A medium transport device includes a device main body, a retard roller configured to form a separation roller pair, and a holder that is provided in the device main body, and that is configured to swingably hold the retard roller at a position where the separation roller pair nips each other and a position where the separation roller pair does not nip each other, and to rotatably hold the retard roller, wherein the retard roller is configured to be attachable to and detachable from the holder.

The present application is based on, and claims priority from JP Application Serial Number 2025-078199, filed May 8, 2025, the disclosure of which is hereby incorporated by reference herein in its entirety.

### BACKGROUND

### 1. Technical Field

The present disclosure relates to a medium transport device and a recording device.

### 2. Related Art

Various medium transport devices have been used in recording devices such as inkjet printers. Among these, there is a medium transport device including a retard roller that forms a separation roller pair in order to suppress multi-feeding of medium. For example, JP-A-2018-16458 discloses a sheet transport device including a retard roller rotatably supported by a first holder.

In a medium transport device including a retard roller, it is convenient if the retard roller can be easily replaced. In the sheet transport device of JP-A-2018-16458, the first holder is rotatably supported by a second holder, and the second holder is detachable with respect to an accommodation section. That is, in the sheet transport device of JP-A-2018-16458, the retard roller can be replaced by detaching the second holder from the accommodation section. However, in such a configuration, it is necessary to detach not only the first holder but also the second holder from the accommodation section in order to replace the retard roller, and it is necessary to take a large space for replacing the retard roller. Therefore, such a technique cannot be adopted for a medium transport device having a configuration in which a large space for replacing the retard roller cannot be secured, such as a small medium transport device.

### SUMMARY

A medium transport device according to the present disclosure for overcoming the above problem includes a device main body; a retard roller configured to form a separation roller pair; and a holder that is provided in the device main body, and that is configured to swingably hold the retard roller at a position where the separation roller pair nips each other and a position where the separation roller pair does not nip each other, and to rotatably hold the retard roller around a rotation shaft, wherein the retard roller is configured to be attachable to and detachable from the holder.

### BRIEF DESCRIPTION OF THE DRAWINGS

FIG. 1 is a perspective view of a multifunction device including a recording device according to an embodiment of the present disclosure, and is a diagram illustrating a state in which a front cover is in a first posture.

FIG. 2 is a perspective view of the multifunction device of FIG. 1, and is a diagram illustrating a state where the front cover is in a second posture.

FIG. 3 is a perspective view of the multifunction device of FIG. 1, and is a diagram illustrating a state where the front cover is in a third posture.

FIG. 4 is a side sectional view of the recording device of FIG. 1, and is a diagram illustrating a state where the front cover is in the first posture.

FIG. 5 is a side sectional view of the recording device of FIG. 1, and is a diagram illustrating a state where the front cover is in the second posture.

FIG. 6 is a side sectional view of the recording device of FIG. 1, and is a diagram illustrating a state where the front cover is in the third posture.

FIG. 7 is a perspective view of the recording device of FIG. 1 in which the front cover is omitted, and is a diagram illustrating a state where a support tray is set to a medium support position from the state of FIG. 2.

FIG. 8 is a schematic internal configuration diagram of the recording device of FIG. 1.

FIG. 9 is a perspective view illustrating a hollow shaft constituting a rotation shaft of a retard roller of the recording device of FIG. 1.

FIG. 10 is a perspective view illustrating an attachment shaft constituting the rotation shaft of the retard roller of the recording device of FIG. 1.

FIG. 11 is a perspective view of the rotation shaft of the retard roller of the recording device of FIG. 1, and is a diagram of a combination of the hollow shaft of FIG. 9 and the attachment shaft of FIG. 10.

FIG. 12 is a perspective view of the retard roller of the recording device of FIG. 1.

FIG. 13 is a perspective view illustrating a state in which the retard roller of the recording device in FIG. 1 is attached on a holder.

FIG. 14 is a perspective view illustrating a state before the retard roller of the recording device of FIG. 1 is attached on the holder.

FIG. 15 is a perspective view illustrating a state where the attachment shaft is inserted into a restriction hole section when the retard roller of the recording device in FIG. 1 is attached on the holder from the state illustrated in FIG. 14.

FIG. 16 is a perspective view illustrating a state where the hollow shaft is held by the holding section when the retard roller of the recording device in FIG. 1 is further attached on the holder from the state illustrated in FIG. 15.

### DESCRIPTION OF EMBODIMENTS

Hereinafter, the present disclosure will be generally described.

A medium transport device according to a first aspect of the present disclosure includes a device main body; a retard roller configured to form a separation roller pair; and a holder that is provided in the device main body, and that is configured to swingably hold the retard roller at a position where the separation roller pair nips each other and a position where the separation roller pair does not nip each other, and to rotatably hold the retard roller around a rotation shaft, wherein the retard roller is configured to be attachable to and detachable from the holder.

According to the present aspect, the retard roller is configured to be attachable to and detachable from the holder. With such a configuration, the replacement of the retard roller alone can be performed. Therefore, the space for replacing the retard roller can be reduced.

The medium transport device according to a second aspect of the present disclosure is an aspect according to the first aspect, wherein in the retard roller, one side of the rotation shaft is inserted into a restriction hole section provided in the holder, and an other side of the rotation shaft is held by a holding section having a recessed shape provided in the holder.

According to the present aspect, the retard roller has a structure in which one side of the rotation shaft is inserted into the restriction hole section provided in the holder, and the other side of the rotation shaft is held by the holding section having the recessed shape provided in the holder. With such a configuration, the replacement of the retard roller alone can be easily performed.

The medium transport device according to a third aspect of the present disclosure is an aspect according to the second aspect, a further including a cover section configured to, in a state where the other side of the rotation shaft is held by the holding section, cover the rotation shaft from a direction opposite to an opening direction of the recessed shape.

According to the present aspect, a cover section configured to, in a state where the other side of the rotation shaft is held by the holding section, cover the rotation shaft from a direction opposite to an opening direction of the recessed shape is provided. With such a configuration, it is possible to suppress the retard roller from being inadvertently detached from the holder.

The medium transport device according to a fourth aspect of the present disclosure is an aspect according to the third aspect, wherein the device main body is configured such that one portion thereof is detachable with respect to an other portion and in the separation roller pair, the retard roller is provided in the one portion and a roller paired with the retard roller is provided in the other portion.

According to the present aspect, the retard roller is provided in the one portion of the device main body, and the roller paired with the retard roller is provided in the other portion of the device main body. In the separation roller pair having such a configuration, when the one portion of the device main body is detached from the other portion, the retard roller is likely to come off from the holder, but by providing the cover section, even when the one portion of the device main body is detached from the other portion, it is possible to suppress the retard roller from coming off from the holder inadvertently.

The medium transport device according to a fifth aspect of the present disclosure is an aspect according to any one of the first to fourth aspects, wherein the rotation shaft is configured by combining a hollow shaft and an attachment shaft inserted into the hollow shaft.

According to the present aspect, the rotation shaft is configured by combining a hollow shaft and an attachment shaft inserted into the hollow shaft. With such a configuration, deformation of the hollow shaft can be suppressed.

The medium transport device according to a sixth aspect of the present disclosure is an aspect according to the fifth aspect, wherein the hollow shaft is formed from a metal plate of metal and the attachment shaft is formed of resin.

According to the present aspect, the hollow shaft is formed from a metal plate of metal, and the attachment shaft is formed of resin. With such a configuration, the rotation shaft can be formed easily and inexpensively.

The medium transport device according to a seventh aspect of the present disclosure is an aspect according to the second or third aspect, wherein in the retard roller, the attachment shaft is inserted into the restriction hole section provided in the holder, and the hollow shaft is held by the recessed shape holding section provided in the holder.

According to the present aspect, in the retard roller, the attachment shaft made of resin is inserted into the restriction hole section, and the hollow shaft made of metal is held by the holding section. With such a configuration, it is possible to easily form a configuration inserted into the restriction hole section, and to improve the accuracy of the attachment position of the retard roller by supporting the hollow shaft made of metal having high rigidity.

A recording device according to a eighth aspect of the present disclosure includes the medium transport device according to any one of the first to seventh aspects and a recording section configured to perform recording on a medium transported by the medium transport device.

According to the present aspect, since the replacement of the retard roller alone can be performed, the recording can be performed while desirably suppressing the multi-feeding of the medium by appropriately replacing the retard roller.

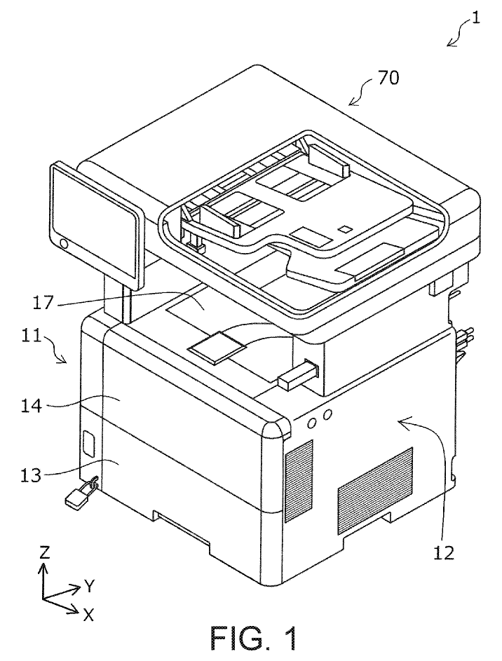

Hereinafter, the present disclosure will be described in detail. First, an overview of a multifunction device 1 having a recording device 11 including a medium transport device 30 according to an embodiment of the present disclosure will be described with reference to FIGS. 1-8. In an X-Y-Z coordinate system illustrated in each drawing, an X-axis direction is a side surface direction of the device, that is, a width direction, a Y-axis direction is a front surface direction (front direction) and a back surface direction of the device, and a Z-axis direction is a height direction and a gravity direction of the device. Note that a direction in which a medium M is transported is referred to as "downstream", and the opposite direction is referred to as "upstream". In each drawing, some constituent members may be omitted or simplified to facilitate understanding of the internal configuration and the like.

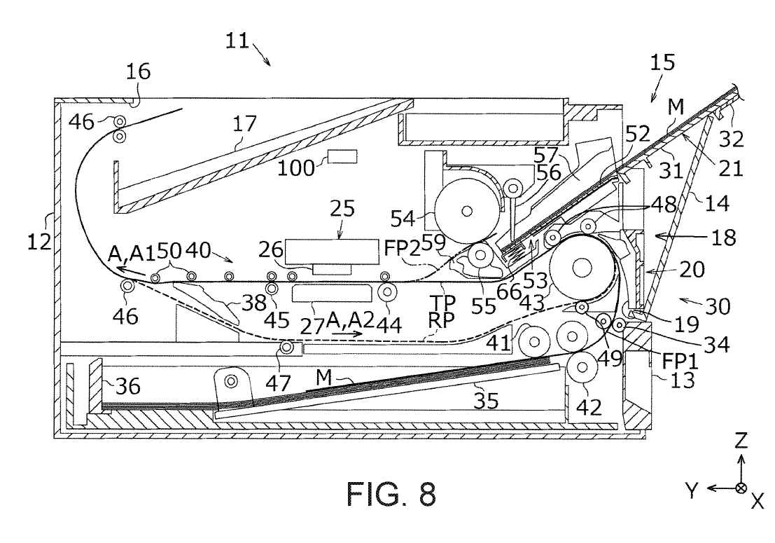

As illustrated in FIGS. 1-3, the multifunction device 1 of the present embodiment includes a reading device 70 capable of reading an image of a document, and the recording device 11 that records an image on the medium M. As illustrated in FIG. 8, the recording device 11 includes the medium transport device 30 and a recording section 25 that performs recording on the medium M transported by the medium transport device 30.

As illustrated in FIGS. 1-8, the recording device 11 includes a device main body 12. As illustrated in FIG. 8 and the like, the recording device 11 includes a medium accommodation cassette 13, a front cover 14, a medium supply section 15, and a stacker 17. The medium accommodation cassette 13 and the medium supply section 15 are supply sources of the medium M. The recording device 11 performs recording on the medium M supplied from the medium accommodation cassette 13 or the medium supply section 15. The recorded medium M is discharged from a discharge port 16 and is stacked on the stacker 17. The medium supply section 15 includes a support tray 21 capable of supporting the medium M. The support tray 21 is stored inside the front cover 14.

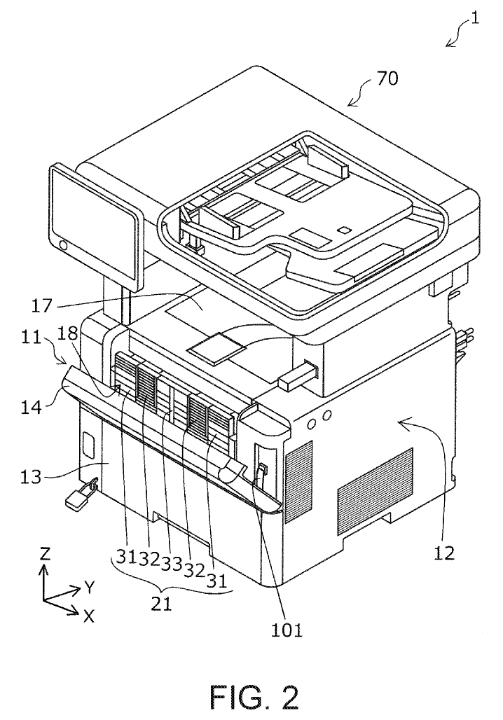

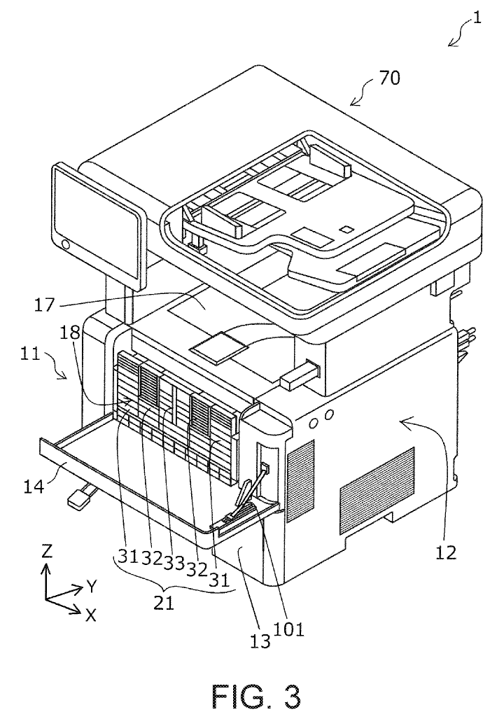

The front cover 14 is pivotable around a pivot shaft 19 extending in the X-axis direction and is provided on the front surface of the device main body 12. As illustrated in FIG. 1, the front cover 14 covers the support tray 21 in the stored state from the front side. The front cover 14 is disposed on the upper side of the medium accommodation cassette 13. The recording device 11 includes an inversion path unit 20. The inversion path unit 20 can be regarded as one portion of the device main body 12. In a state where the front cover 14 of the recording device 11 is opened, the inversion path unit 20 is exposed. The inversion path unit 20 is mounted to an opening section 18 provided in a front portion of the device main body 12. The inversion path unit 20 includes the support tray 21. As illustrated in FIGS. 2 and 3, the support tray 21 is exposed by opening the front cover 14.

The inversion path unit 20 is configured to be attachable to and detachable from the device main body 12. In other words, the device main body 12 is configured such that the inversion path unit 20, which is the one portion of the device main body 12, is detachable from an other portion of the device main body 12. As illustrated in FIG. 8, the recording device 11 includes the medium transport device 30. The medium transport device 30 includes the device main body 12 and the inversion path unit 20 that is detachably mounted on the device main body 12. The inversion path unit 20 is, in the mounted state, locked to the device main body 12.

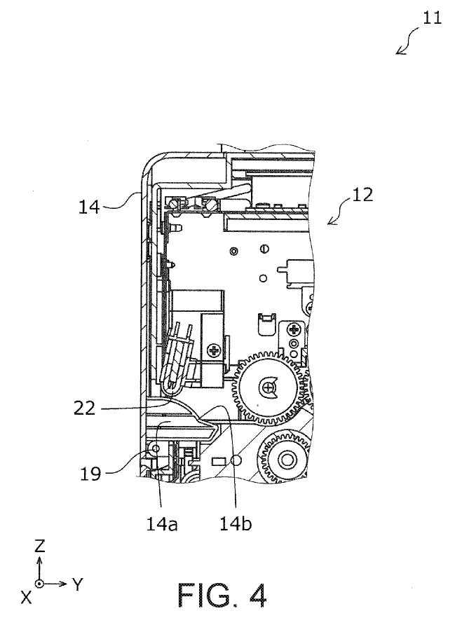

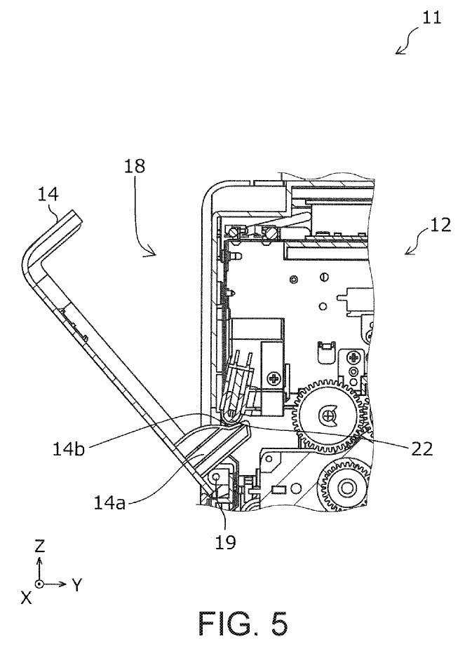

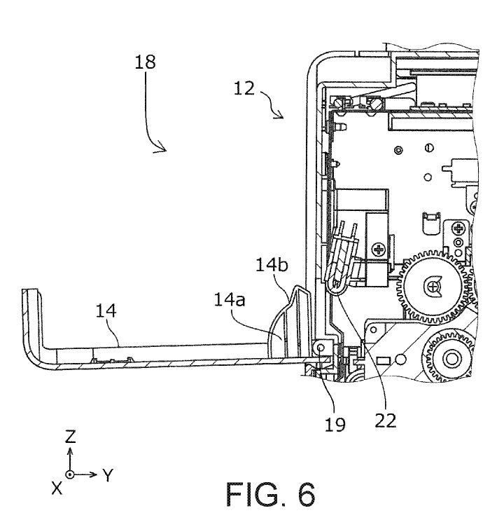

The medium accommodation cassette 13 is provided below the inversion path unit 20. The medium accommodation cassette 13 is configured to be pulled out in a -Y direction from the rear surface toward the front surface of the device main body 12. The medium accommodation cassette 13 is mounted on the device main body 12 by being moved in a +Y direction. The front cover 14 can take a first posture, which is a closed position as illustrated in FIGS. 1 and 4, a second posture, which is a first open position as illustrated in FIGS. 2 and 5, and a third posture, which is a second open position as illustrated in FIGS. 3 and 6. As illustrated in FIGS. 3 and 6, the front cover 14 opens the opening section 18 in a substantially horizontal state in the third posture.

Here, as illustrated in FIGS. 4-6, the device main body 12 is provided with a lock pin 22. As illustrated in FIGS. 4-6, the front cover 14 is provided with an engagement section 14a, and the lock pin 22 engages with the engagement section 14a in the second posture illustrated in FIG. 5. Specifically, a shallow recess section 14b is formed in the engagement section 14a, and the lock pin 22 is configured to be fitted into the recess section 14b in the second posture. The front cover 14 can maintain the second posture with respect to the device main body 12 by the lock pin 22 engaging with the engagement section 14a. Note that since the recess section 14b is shallow, the user can easily move the front cover 14 from the second posture to the third posture by manually opening it, and can easily move the front cover 14 from the second posture to the first posture by manually closing it.

As illustrated in FIG. 3, the device main body 12 and the front cover 14 are connected to each other by a strap belt 101. In the third posture, as illustrated in FIG. 3, the strap belt 101 is in a stretched state. With the device main body 12 and the front cover 14 configured as described above, the front cover 14 can be maintained in the third posture without being excessively opened with respect to the device main body 12.

The front cover 14 is openable and closable by pivoting around the pivot shaft 19. The front cover 14 is restricted from moving in a pivot direction in each of the first posture as illustrated in FIG. 1, the second posture as illustrated in FIG. 2, and the third posture as illustrated in FIG. 3. As described above, in the medium transport device 30 of the present embodiment, the inversion path unit 20 is attachable to and detachable from the device main body 12. Specifically, in the medium transport device 30 of the present embodiment, the inversion path unit 20 can be attached and detached by disposing the front cover 14 in the third posture. By detaching the inversion path unit 20 from the device main body 12, when a jam or the like occurs in a transport path T of the medium M, the medium M in which the jam has occurred can be easily removed.

As illustrated in FIGS. 2 and 3, the support tray 21 includes a first tray 31, a second tray 32, and a third tray 33. The second tray 32 is configured to be switchable between a pulled-out state in which the second tray 32 is pulled out from the first tray 31 and a stored state in which the second tray 32 is stored in the first tray 31. The third tray 33 is configured to be switchable between a pulled-out state in which the third tray 33 is pulled out from the second tray 32 and a stored state in which the third tray 33 is stored in the second tray 32.

As illustrated in FIG. 8, the recording device 11 includes the medium transport device 30 and the recording section 25 that performs recording on the medium M transported by the medium transport device 30. The recording device 11 includes a transport section 40 and the recording section 25 in the device main body 12. The transport section 40 transports the medium M. Note that the inversion path unit 20 includes a part of the medium supply section 15 and a part of the transport section 40. The recording device 11 includes a control section 100. The control section 100 controls the driving of each constituent member of the recording device 11.

As illustrated in FIG. 8, the transport section 40 transports the medium M along paths TP, RP, FP1, and FP2. The transport path T of the medium M includes a first feed path FP1, a second feed path FP2, a main transport path TP, and an inversion path RP. The main transport path TP is a path along which the transport section 40 transports the medium M from the medium accommodation cassette 13. The main transport path TP is indicated by a solid line in FIG. 8, and includes the first feed path FP1. The first feed path FP1 is a path for feeding the medium M from the medium accommodation cassette 13.

In FIG. 8, the inversion path RP is indicated by a dashed line. The inversion path RP is, when performing double-sided recording, a path for inverting the medium M on which recording on a first surface (front surface) is completed. In FIG. 8, the second feed path FP2 is indicated by a two dot chain line. The second feed path FP2 is a path through which the medium supply section 15 supplies the medium M supported by the support tray 21. The second feed path FP2 merges with the main transport path TP at a position upstream of a recording position of the recording section 25 in a transport direction A. Note that hereinafter a direction in which the medium M is transported toward the discharge port 16 along the main transport path TP is referred to as a first transport direction A1. A direction in which the medium M is transported along the inversion path RP is referred to as a second transport direction A2.

The medium accommodation cassette 13 includes a placement plate 35 on which the medium M can be placed. Plural sheets of the medium M can be placed on the placement plate 35 in a stacked state. The medium accommodation cassette 13 includes an edge guide section 36 capable of positioning the plurality of medium M placed on the placement plate 35. The placement plate 35 is supported so as to be tiltable in a state of being biased upward. When the medium accommodation cassette 13 is mounted on the device main body 12, the placement plate 35 is tilted upward by the biasing force.

The transport section 40 includes a plurality of rollers disposed along the main transport path TP. Specifically, the transport section 40 includes a first feed roller 41, a separation roller pair 42, a transport roller pair 34, an inversion roller 43, a transport roller pair 44, a discharge roller pair 45, and a discharge roller 46. The transport section 40 includes a transport roller 47 that transports the medium M along the inversion path RP. The transport section 40 further includes a plurality of guide rollers 48 and 49 disposed along the outer peripheral of the inversion roller 43. The guide rollers 48 and 49 are driven rollers. The transport section 40 includes a plurality of guide rollers 50 that guide the medium M along the main transport path TP.

The first feed roller 41 is disposed above a downstream end portion of the medium accommodation cassette 13 in a medium supply direction. The uppermost sheet of the plural sheets of the medium M placed on the placement plate 35 in the medium accommodation cassette 13 contacts against the first feed roller 41. By rotation of the first feed roller 41, the uppermost sheet of the medium M is fed from the medium accommodation cassette 13. The separation roller pair 42 is disposed at a position downstream of the first feed roller 41 in a feed direction. The separation roller pair 42 separates one sheet of the medium M fed from the first feed roller 41. By this, multi-feeding of the medium M is suppressed.

The inversion roller 43 is disposed at a position on the downstream side of the separation roller pair 42 in the feed direction. The inversion roller 43 is a roller having a larger diameter than the first feed roller 41. The plurality of guide rollers 48 are disposed along the outer peripheral surface of the inversion roller 43. The plurality of guide rollers 48 rotate following the rotation of the inversion roller 43 while nipping the medium M between the outer peripheral surface of the inversion roller 43. The inversion roller 43 rotates in the counterclockwise direction in FIG. 8. The medium M is transported along a path along the outer peripheral of the inversion roller 43 in a state of being nipped between the inversion roller 43 and the plurality of guide rollers 48. By this, the transport direction A of the medium M is changed to a direction substantially opposite to the feed direction from the medium accommodation cassette 13 while the medium M is inverted. The medium M fed from the inversion roller 43 is transported downstream in the transport direction A toward the recording position of the recording section 25.

The recording section 25 records on the medium M. The recording section 25 performs recording on the medium M at the recording position on the main transport path TP. The recording section 25 is disposed at a position opposing the main transport path TP from above. The recording section 25 includes a recording head 26 that performs recording on the medium M. The recording head 26 may be a line head of a line recording type having a length corresponding to the maximum width of the medium M, or may be a serial recording type. In the serial recording type, recording is performed on the medium M by alternately performing a transport operation in which the transport section 40 transports the medium M to the next recording position and a recording operation in which the recording section 25 records one line (one pass) on the medium M while moving in the X-axis direction (scanning direction).

A support section 27 is disposed at a position opposing the recording section 25 with the main transport path TP interposed therebetween. The recording head 26 performs recording on the medium M supported by the support section 27. The support section 27 supports a portion of the medium M at the recording position. The recording section 25 performs recording on a portion of the medium M supported by the support section 27.

The medium supply section 15 supplies the medium M supported by the support tray 21. The medium supply section 15 includes a placement section 52, a hopper section 53, a supply roller 54, a retard roller 55, a medium detection section 56, and an edge guide 57. The placement section 52 is disposed in a portion between the support tray 21 and the supply roller 54. The medium M supported by the support tray 21 is placed on the placement section 52. The placement section 52 places a downstream portion in the supply direction of the medium M supported by the support tray 21. The placement section 52 is disposed in a posture inclined at an inclination angle corresponding to the inclination angle of the support tray 21 during use. The placement section 52 is supported so as to be tiltable with the upper end side as a fulcrum. The edge guide 57 is operated when the medium M placed on the placement section 52 is positioned in the X-axis direction.

The hopper section 53 is disposed below the placement section 52. The hopper section 53 switches the inclination angle of the placement section 52. The hopper section 53 has a function of pushing up the placement section 52 from a standby position illustrated in FIG. 8 to a feed position when the medium M is fed. The hopper section 53 is driven via a cam (not illustrated) by power of a supply motor (not illustrated) which is a drive source of the supply roller 54. When the supply roller 54 starts rotating, the locking of the placement section 52 at the standby position is released by the cam. The placement section 52 is moved from the standby position to the feed position by the biasing force of a spring 66 constituting the hopper section 53. The medium M on the placement section 52 that moved to the feed position is pushed against the supply roller 54.

In this state, the supply roller 54 rotates in the clockwise direction in FIG. 8. The supply roller 54 and the retard roller 55 rotate while nipping the uppermost medium M supported by the support tray 21, thereby supplying the medium M one sheet at a time. The retard roller 55 separates the medium M supplied by the supply roller 54 by one sheet. That is, the retard roller 55 forms a separation roller pair together with the supply roller 54. The retard roller 55 is provided in the inversion path unit 20, and when the inversion path unit 20 is detached from the device main body 12, the retard roller 55 is no longer opposed to the supply roller 54, which remains in the device main body 12. Note that details of the retard roller 55, which is a main portion in the recording device 11 of the present embodiment, will be described later.

Before the supply roller 54 completes one rotation, a leading edge of the medium M fed along the second feed path FP2 reaches a position where the leading edge is nipped by the transport roller pair 44. After the supply roller 54 completes one rotation, the placement section 52 returns from the feed position to the standby position via the cam. The medium M to be fed next time and thereafter on the placement section 52 is separated from the supply roller 54. In this manner, the medium M on the placement section 52 is fed one sheet at a time by rotation of the supply roller 54 and the driving of the hopper section 53, which is linked with the rotation of the supply roller 54. The transport roller pair 44 transports the nipped medium M downstream in the transport direction A toward the recording position of the recording section 25.

Note that the medium detection section 56 detects the presence or absence of the medium M on the placement section 52. When a recording execution instruction is received, the control section 100 rotates the supply roller 54 by driving the supply motor if the medium detection section 56 detects the medium M on the placement section 52 at that time. When the medium detection section 56 does not detect the medium M on the placement section 52, the control section 100 does not rotate the supply roller 54.

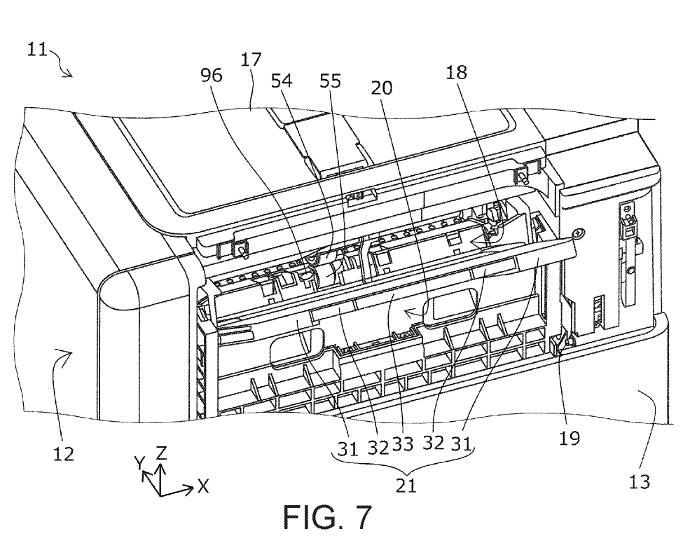

Here, as described above, the medium transport device 30 in the recording device 11 of the present embodiment includes the device main body 12 and the retard roller 55, which forms the separation roller pair together with the supply roller 54. Next, the retard roller 55, which is a main portion of the recording device 11 of the present embodiment, will be described below with reference to FIGS. 7 and 9-16.

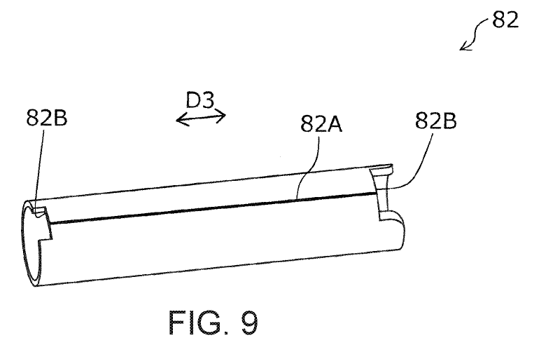

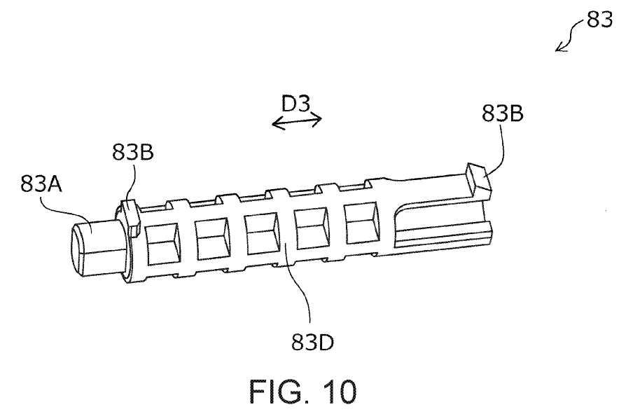

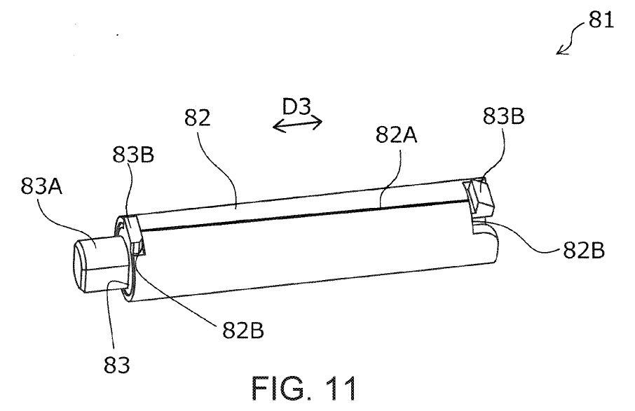

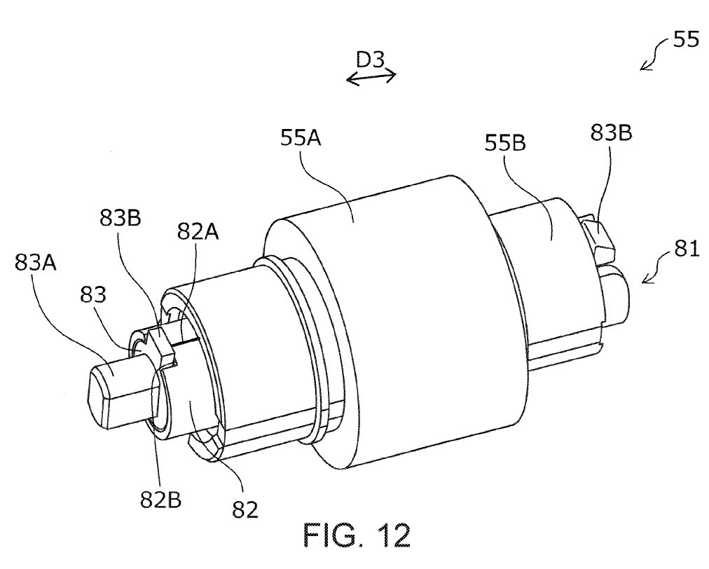

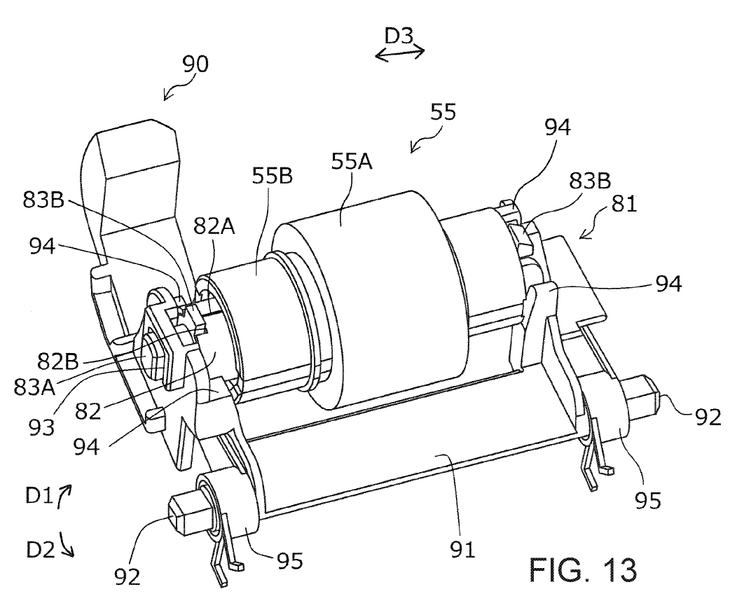

As illustrated in FIG. 12 and the like, the retard roller 55 of the present embodiment includes a rubber roller 55A that nips the medium M, a cylindrical member 55B to which the rubber roller 55A is attached, and a rotation shaft 81 inserted into the cylindrical member 55B. The rotation shaft 81 of the retard roller 55 is attached to a holder 90 illustrated in FIG. 13 and the like. The rotation shaft 81 is configured by combining a hollow shaft 82 illustrated in FIG. 9 and an attachment shaft 83 that is illustrated in FIG. 10 and that, as illustrated in FIG. 11, is inserted into the hollow shaft 82 and by inserting the attachment shaft 83 into the hollow shaft 82.

As illustrated in FIG. 13, the holder 90 has a base section 91, a swing shaft 92 provided in the base section 91, a restriction hole section 93 to which one side of the rotation shaft 81 of the retard roller 55 is attached, and a holding section 94 having a recessed shape to which the other side of the rotation shaft 81 of the retard roller 55 is attached. Note that as illustrated in FIG. 13, in the present embodiment, the holding section 94 is also provided on the one side of the rotation shaft 81 of the retard roller 55. That is, holding sections 94 are provided on both end sides of the extending direction D3 of the rotation shaft 81. In this manner, by supporting the rotation shaft 81 by the holding sections 94 on both sides of the extending direction D3 in which the rotation shaft 81, it is possible to increase the restriction area of the rotation shaft 81, and it is possible to suppress the occurrence of rotational rattling.

A coil spring 95 is attached to the swing shaft 92, and the holder 90 is configured to be swingable in the swing direction D1 and the swing direction D2 around the swing shaft 92 in a state of supporting the retard roller 55. In detail, the holder 90 holds the retard roller 55 so that it is swingable between a position where the separation roller pair, which is provided in the device main body 12 and consists of the supply roller 54 and the retard roller 55, nips and a position where the separation roller pair does not nip, and also holds the retard roller 55 so that it can rotate around the rotation shaft 81 of the retard roller 55. More specifically, when the medium M supported by the support tray 21 is fed toward the recording section 25, the retard roller 55 is disposed at a position where the retard roller 55 nips the supply roller 54 in order to suppress the multi-feeding of the medium M, and when recording is started by the recording section 25, the retard roller 55 is disposed at a position where the retard roller 55 does not nip the supply roller 54 in order to suppress an excessive transport load from being applied to the transported medium M.

The retard roller 55 is configured to be attachable to and detachable from the holder 90 even in a state where the inversion path unit 20 is not detached from the device main body 12. The recording device 11 of the present embodiment has such a configuration, thereby the retard roller 55 can be replaced alone. Therefore, the recording device 11 of the present embodiment can reduce the space for replacing the retard roller 55.

As illustrated in FIG. 13, in the retard roller 55 of the present embodiment, one side of the rotation shaft 81 of the retard roller 55 is inserted into the restriction hole section 93 provided in the holder 90, and the other side of the rotation shaft 81 of the retard roller 55 is held by the holding section 94, which is a recessed shape provided in the holder 90. With such a configuration, the replacement of the retard roller 55 alone can be easily performed. For example, if a structure is adopted in which one side of the rotation shaft 81 of the retard roller 55 is not inserted into the restriction hole section 93 provided in the holder 90 and is held by the holding section 94 on both of one side and the other side of the rotation shaft 81 of the retard roller 55, the retard roller 55 is likely to be displaced in the extending direction D3 of the rotation shaft 81, and there is a concern that the attachment and detachment load of the retard roller 55 may increase.

Here, a method of assembling the retard roller 55 will be described with reference to FIGS. 9-12. First, the attachment shaft 83 illustrated in FIG. 10 is inserted into the hollow shaft 82 illustrated in FIG. 9. The hollow shaft 82 is formed by rolling a flat metal plate into a cylindrical shape. Note that as illustrated in FIG. 9, the hollow shaft 82 is provided with an engaged section 82B at both ends, in the extending direction D3 of the rotation shaft 81, of the position 82A where the metal plate end portions are joined.

The attachment shaft 83 is a rod-shaped member made of resin. The attachment shaft 83 is provided with an engagement section 83B at both ends of a base section 83D in the extending direction D3 of the rotation shaft 81. The base section 83D has hollowed out sections so as to be easily inserted into the hollow shaft 82. The base section 83D has a protrusion section 83A at one side end portion in the extending direction D3 of the rotation shaft 81.

When the attachment shaft 83 illustrated in FIG. 10 is inserted into the hollow shaft 82 illustrated in FIG. 9, the state illustrated in FIG. 11 is obtained. In the state illustrated in FIG. 11, the engagement section 83B of the attachment shaft 83 engages with the engaged section 82B of the hollow shaft 82. Therefore, the hollow shaft 82 and the attachment shaft 83 are desirably fixed. Next, the rotation shaft 81 illustrated in FIG. 11 is inserted into the cylindrical member 55B to which the rubber roller 55A is attached, thereby the assembly of the retard roller 55 is completed as illustrated in FIG. 12.

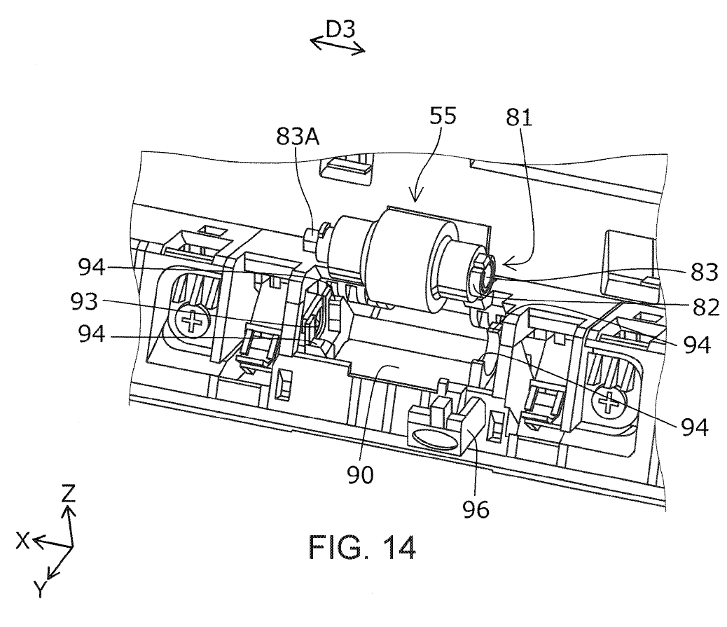

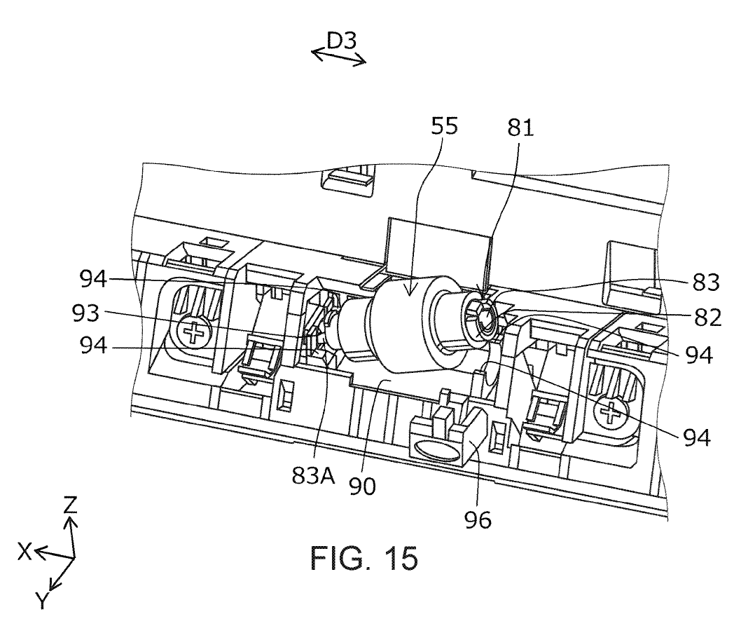

Next, a method of attaching and detaching the retard roller 55 will be described mainly with reference to FIGS. 14-16. From the state before the retard roller 55 is attached on the holder 90 illustrated in FIG. 14, first, as illustrated in FIG. 15, with respect to side end portion in the extending direction D3 of the rotation shaft 81 of the base section 83D, the protrusion section 83A of the attachment shaft 83 constituting the rotation shaft 81 is inserted into the restriction hole section 93 of the holder 90. Note that the protrusion section 83A and the restriction hole section 93 are configured to prevent the protrusion section 83A from rotating relative to the restriction hole section 93 so that the protrusion section 83A does not rotate relative to the restriction hole section 93.

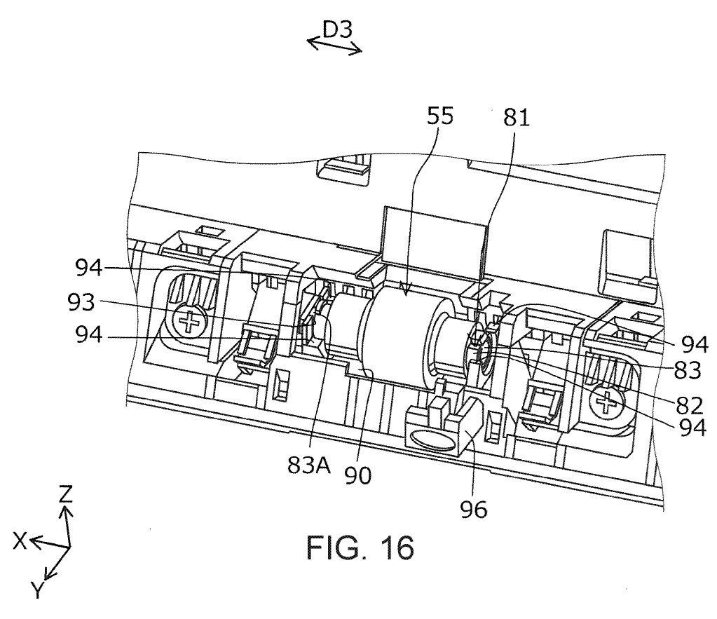

Then, from the state illustrated in FIG. 15, as illustrated in FIG. 16, with respect to the other side end portion in the extending direction D3 of the rotation shaft 81 of the base section 83D, the hollow shaft 82 constituting the rotation shaft 81 is placed in the holding section 94 of the recessed shape of the holder 90 and, by this, the hollow shaft 82 is held in the holding section 94. The state illustrated in FIG. 16 corresponds to the state illustrated in FIG. 13. Note that as illustrated in FIGS. 14-16, the holder 90 is provided with a cover section 96 capable of covering the rotation shaft 81. By covering the rotation shaft 81 with the cover section 96 from the state illustrated in FIG. 16, the cover state illustrated in FIG. 7 is obtained.

In this manner, the medium transport device 30 of the present embodiment includes the cover section 96 that covers the rotation shaft 81 from a direction opposite to the opening direction of the recessed shape of the holding section 94, that is, from the upper direction in a state where the other side of the rotation shaft 81 is held by the holding sections 94. With such a configuration, it is possible to prevent the retard roller 55 from being inadvertently detached from the holder 90. However, the cover section 96 may be omitted. For example, when the holding sections 94 and the hollow shaft 82 are attached by snap-fitting, the retard roller 55 can be prevented from being inadvertently detached from the holder 90 even in a configuration without the cover section 96.

As described above, in the medium transport device 30 of the present embodiment, the inversion path unit 20, which can be regarded as a portion of the device main body 12, can be removed from the device main body 12. The inversion path unit 20 is provided with the retard roller 55, but is not provided with the supply roller 54. In other words, in the medium transport device 30 of the present embodiment, the device main body 12 is configured such that the inversion path unit 20, which is the one portion of the device main body 12, is detachable from the other portion. In the separation roller pair, the retard roller 55 is provided in the inversion path unit 20 as one portion and the supply roller 54 paired with the retard roller is provided in another portion other than the inversion path unit 20.

In the separation roller pair having such a configuration, when the one portion of the device main body 12 is detached from the other portion, the retard roller 55 is easily detached from the holder 90. However, the medium transport device 30 of the present embodiment includes the cover section 96, thereby even when the one portion of the device main body 12 is detached from the other portion, it is possible to suppress the retard roller 55 from being inadvertently detached from the holder 90.

As described above, the rotation shaft 81 of the present embodiment is configured by combining the hollow shaft 82 and the attachment shaft 83 inserted into the hollow shaft 82. With such a configuration, deformation of the hollow shaft 82 can be suppressed. With such a configuration, in a case where one of the hollow shaft 82 and the attachment shaft 83 is reusable, it is possible to reuse it.

The hollow shaft 82 of the present embodiment is formed from a metal plate of metal, and the attachment shaft 83 from the present embodiment is formed of resin. With such a configuration, the rotation shaft 81 can be formed easily and inexpensively.

As described above, in the retard roller 55 of the present embodiment, the attachment shaft 83 is inserted into the restriction hole section 93, and the hollow shaft 82 is held by the holding sections 94. With such a configuration, it is possible to easily form a configuration that is inserted into the restriction hole section 93, and to improve the accuracy of the attachment position of the retard roller 55 by supporting the hollow shaft 82 made of metal having high rigidity.

Here, when the present embodiment is described from the viewpoint of the recording device, the recording device 11 of the present embodiment includes the medium transport device 30 having the configuration as in the present embodiment, and the recording section 25 that performs recording on the medium M transported by the medium transport device 30. Therefore, since the retard roller 55 can be replaced alone, it is possible to perform recording while appropriately replacing the retard roller 55 and suitably suppressing multi-feeding of the medium M.

The present disclosure is not limited to the above described embodiments, and can be realized by various configurations without departing from the scope of the present disclosure. For example, the technical features in the embodiments corresponding to the technical features in the respective aspects described in the summary of the present disclosure can be appropriately replaced or combined in order to solve some or all of the above described problems or in order to achieve some or all of the above described effects. If the technical features are not described as essential in this specification, the technical features can be appropriately omitted. Specifically, in the present embodiment, the transport section of the medium M from the support tray 21 of the recording device 1 is used as the medium transport device, but the medium transport device is not limited to such a configuration, and may be a transport section of the medium M from the medium accommodation cassette 13 of the recording device 1, a transport section of the medium M from a medium accommodation cassette that can be added to the recording device 1, a transport section of the medium M of an device other than the recording device 1 such as a scanner, or the like.

What is claimed is:

1. A medium transport device comprising:
a device main body;
a retard roller constituting one of a separation roller pair; and
a holder that is provided in the device main body and that is configured to swingably hold the retard roller at a position where the separation roller pair nips each other and a position where the separation roller pair does not nip each other and to rotatably hold the retard roller, wherein
the retard roller is configured to be attachable to and detachable from the holder.

2. The medium transport device according to claim 1, wherein
the retard roller includes a rotation shaft, one side of the rotation shaft is inserted into a restriction hole section provided in the holder, and an other side of the rotation shaft is held by a holding section having a recessed shape provided in the holder.

3. The medium transport device according to claim 2, further comprising:
a cover section configured to, in a state where the other side of the rotation shaft is held by the holding section, cover the rotation shaft from a direction opposite to an opening direction of the recessed shape.

4. The medium transport device according to claim 3, wherein
the device main body is configured such that one portion thereof is detachable with respect to an other portion and
in the separation roller pair, the retard roller is provided in the one portion and a roller paired with the retard roller is provided in the other portion.

5. The medium transport device according to claim 1, wherein
the rotation shaft is configured by combining a hollow shaft and an attachment shaft inserted into the hollow shaft.

6. The medium transport device according to claim 5, wherein
the hollow shaft is formed from a metal plate of metal and
the attachment shaft is formed of resin.

7. The medium transport device according to claim 6, wherein
in the retard roller, the attachment shaft is inserted into the restriction hole section provided in the holder, and the hollow shaft is held by the recessed shape holding section provided in the holder.

8. A recording device comprising:
the medium transport device according to claim 1 and
a recording section configured to perform recording on a medium transported by the medium transport device.
